(19) United States
(12) Patent Application Publication
(10) Pub. No.: US 2008/0296456 A1
(43) Pub. Date: Dec. 4, 2008

(54) Drywall mount

(76) Inventor: Chin-Hsiung Lien, El Monte, CA (US)

Correspondence Address: DAVID AND RAYMOND PATENT FIRM, 108 N. YNEZ AVE., SUITE 128, MONTEREY PARK, CA, 91754, US

(21) Appl. No.: 11/810,187

(22) Filed: Jun. 4, 2007

(51) Int. Cl. F16B 45/00

(52) U.S. Cl. 248/304

(57) ABSTRACT

A drywall mount for supporting an item on a drywall includes an elongated shank body having an upper portion defining an upper end, and a lower portion defining a lower end for holding the item in position, and an inserting body integrally and inclinedly extended from an upper portion of the shank body, wherein the inserting body has a sharp tip rearwardly and downwardly extended from the upper end of the shank body for inserting into the drywall until the shank body is rest on a front surface of the drywall so as to suspendedly support the item on the front surface of the drywall.

### BACKGROUND OF THE PRESENT INVENTION

1. Field of Invention

The present invention relates to a wall support, and more particularly to a drywall mount, which enhances the tensile strength, pullout resistance, and shear strength to support an object on the drywall without substantially damaging the structure of the drywall.

2. Description of Related Arts

Drywall, also commonly known as gypsum board, or plasterboard, is common manufactured building material used as the interior wall and ceiling. In compassion with the exterior wall, the strength of the drywall is relatively weak to support items hung thereon.

However, the items, such as paintings or shelves, are considered as common objects to be hung on the drywall. A wall anchor is commonly used in conjunction with nail or screw to enhance the overall hanging strength of the drywall. However, such wall anchor has several drawbacks.

One type of wall anchor is an expansion anchor inserting into the drywall such that when a screw is screwed into the expansion anchor, the expansion anchor is expanded behind the inner side of the drywall so as to enhance the supporting force of the drywall. However, such expansion anchor requires a relatively large pre-drilled aperture on the drywall and damages the structure of the drywall.

Another type of wall anchor is a picture hanger affixing on the drywall through a nail. The advantages of such picture hanger are that the picture hanger does not require any predrilled aperture and does not seriously damage the structure of the drywall. However, such picture hanger can only be used to support a light weight item such as picture.

It is always a challenge to minimize the damage of the drywall but to enhance the supporting force against the drywall.

### SUMMARY OF THE PRESENT INVENTION

A main object of the present invention is to provide a drywall mount, which enhances the tensile strength, pullout resistance, and shear strength to support an object on the drywall without substantially damaging the structure of the drywall.

Another object of the present invention is to provide a drywall mount, which is capable of installation in dry wall without any pre-drilled aperture on the drywall.

Another object of the present invention is to provide a drywall mount, wherein the shank body is integrally extended to the inserting body to form a one piece integrated structure to provide a rigid loading support for the item being hung on the drywall.

Another object of the present invention is to provide a drywall mount, which is capable of being easily inserted into a drywall or the like.

Another object of the present invention is to provide a drywall mount, which is simple in structure and which can be readily manufactured and assembled with a minimum of cost.

Accordingly, in order to accomplish the above objects, the present invention provides a drywall mount for supporting an item on a drywall, comprising an elongated shank body having an upper portion defining an upper end, and a lower portion defining a lower end for holding the item in position, and an inserting body integrally and inclinedly extended from an upper portion of the shank body, wherein the inserting body has a sharp tip rearwardly and downwardly extended from the upper end of the shank body for inserting into the drywall until the shank body is rest on a front surface of the drywall so as to suspendedly support the item on the front surface of the drywall.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a drywall mount according to a first preferred embodiment of the present invention.

FIG. 2 is a sectional view of the drywall mount according to the above first preferred embodiment of the present invention.

FIGS. 3A and 3B illustrate an alternative mode of the drywall mount according to the above first preferred embodiment of the present invention.

FIG. 4 is a perspective view of a drywall mount according to a second preferred embodiment of the present invention.

FIG. 5 is a side view of the drywall mount according to the above second preferred embodiment of the present invention.

### DETAILED DESCRIPTION OF THE PREFERRED EMBODIMENT

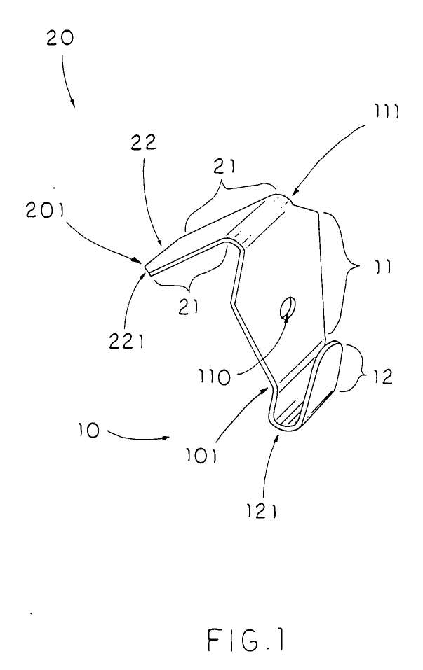

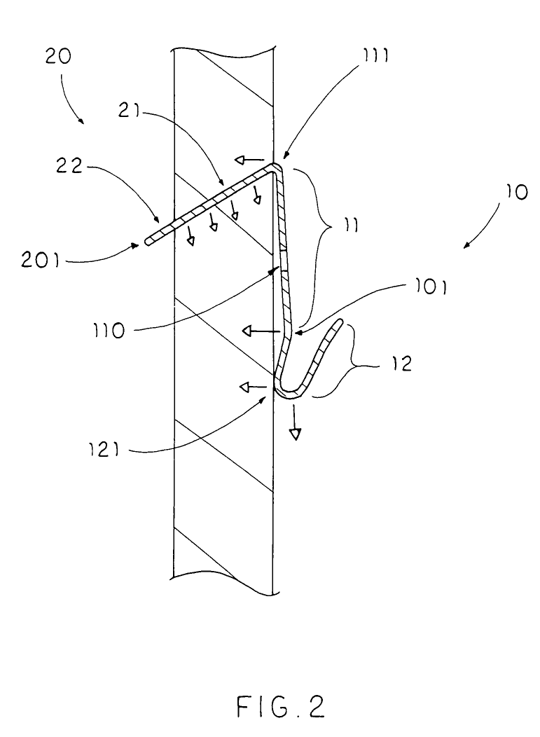

Referring to FIGS. 1 and 2 of the drawings, a drywall mount for supporting an item on a drywall according a first preferred embodiment of the present invention is illustrated, wherein the drywall mount comprises an elongated shank body 10 and an inserting body 20.

As shown in FIG. 1, the shank body 10 has an upper portion 11 defining an upper end 111, and a lower portion 12 defining a lower end 121, wherein the shank body 10 is adapted for holding the item in position. Accordingly, the upper portion 11 of the shank body 10 is preferably longer than the lower portion 12 thereof.

The inserting body 20 is integrally and inclinedly extended from the upper portion 11 of the shank body 10, wherein the inserting body 20 has a sharp tip 201 rearwardly and downwardly extended from the upper end 111 of the shank body 10 for inserting into the drywall until the shank body 10 is rest on a front surface of the drywall so as to suspendedly support the item on the front surface of the drywall.

Accordingly, the drywall mount of the present invention is preferably made of rigid material such as metal such that the item can be securely hung on the drywall via the drywall mount. It is worth to mention that the shank body 10 is integrally extended to the inserting body 20 to form a one piece integrated structure of the drywall mount of the present invention to provide a rigid loading support for the item being hung on the drywall.

According to the preferred embodiment, the shank body 10 is frontwardly bent at a common edge 101 between the upper and lower portions 11, 12 that when the shank body 10 is rest on the front surface of the drywall, the upper and lower ends 111, 121 of the shank body 10 are biased against the drywall to enhance a strength of the shank body 10. It is worth to mention that the bending structure of the shank body 10 can enhance the shear strength thereof. In other words, when the inserting body 20 is inserted into the drywall, the upper and lower ends 111, 121 of the shank body 10 are substantially biased on the front surface of the drywall to define a clearance between a rear side of the shank body 10 and the front surface of the drywall so as to form a two-point support on the drywall.

The lower portion 12 of the shank body 10 is formed in U-shape to configure as a hanging hook for coupling with the item so as to suspendedly hang the item on the drywall. It is worth to mention that the lower portion 12 of the shank body 10 can be formed in other configuration to hold the item in position.

As shown in FIG. 1, the inserting body 20 has a neck portion 21 rearwardly and inclinedly extended from the upper end 111 of the shank body 10 and a teething head 22 which defines the sharp tip 201 thereat and is integrally extended from the neck portion 21. A length of the neck portion 21 is larger than a thickness of the drywall, such that when the inserting body 20 inserts into the drywall, the neck portion 21 is extended through the drywall while the teething head 22 is substantially engaged with a rear surface of the drywall.

Accordingly, the neck portion 21 of the inserting body 20 is integrally extended from the upper end 111 of the shank body 10 to insert into the drywall. More importantly, the neck portion 21 of the inserting body 20 is downwardly and rearwardly extended from the upper end 111 of the shank body 10 such that when the inserting body 20 is inserted into the drywall, the neck portion 21 of the inserting body 20 is inclinedly embedded into the drywall. Therefore, when the downward loading force is applied at the lower portion 12 of the shank body 10 by means of the weight of the item, the inserting body 20 is adapted to evenly distribute the downward loading force to the surrounding area of the drywall. In other words, the inclination of the inserting body 20 is adapted to prevent the distortion of the drywall mount when the downward loading force is applied at the lower portion 12 of the shank body 10. In addition, the downward loading force at the lower portion 12 of the shank body 10 will further ensure the upper and lower ends 111, 121 of the shank body 10 being substantially biased on the front surface of the drywall with respect to the bending structure of the shank body 10.

According to the preferred embodiment, an inclination angle of the inserting body 20 has a range from 45° to 70° with respect to the shank body 10. Preferably, the inclination angle of the inserting body 20 is 60° with respect to the shank body 10.

The teething head 22, having a triangular shape, is integrally and rearwardly extended from the neck portion 21 of the inserting body 20, wherein the teething head 22 is arranged in such a manner that when the inserting body 20 is inserted into the drywall, the teething head 22 is penetrated though the rear surface of the drywall, so as to enhance the pullout resistance of the drywall mount of the present invention.

In order to further enhance the hanging support of the item via the drywall mount of the present invention, the shank body 10 further contains an aperture 110 provided at the upper portion 11 thereof at a position above the common edge 101 for a fastener affixing to the drywall through the aperture 110. It is worth to mention that when the fastener is affixed to the drywall through the aperture 110, the shank body 10 provides a three-point support on the drywall to substantially support the item on the drywall. Alternatively, the aperture 110 can be used as a hanging aperture that the item can be engaged with the aperture 110 via a conventional hook to suspendedly hang the item on the drywall.

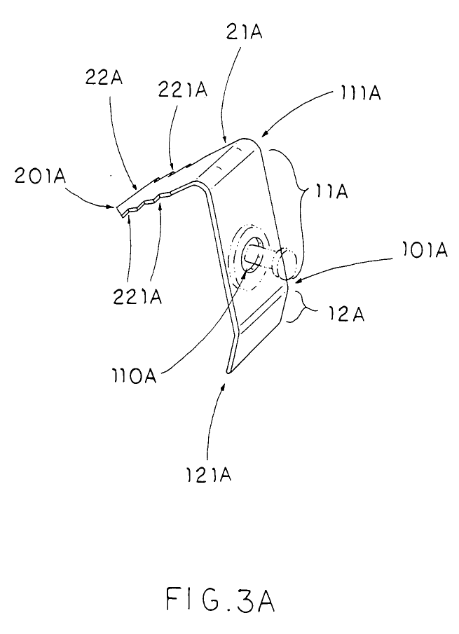

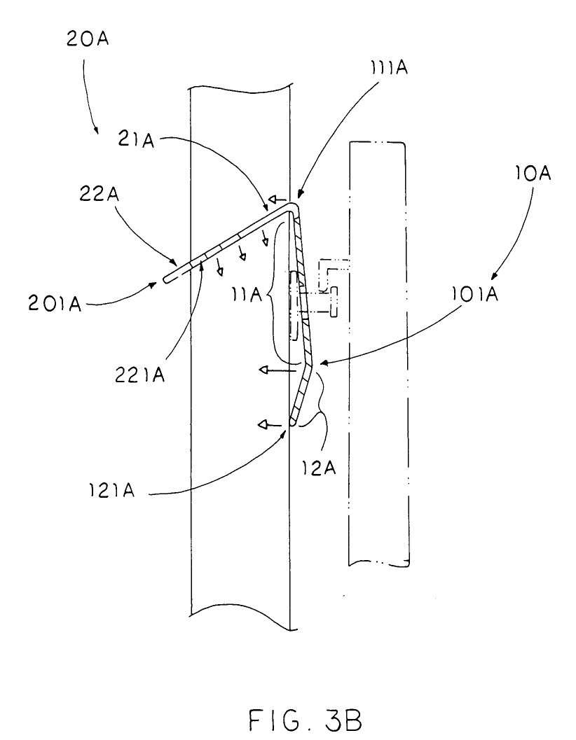

FIGS. 3A and 3B illustrate an alternative mode of the drywall mount according to the first preferred embodiment. Accordingly, the shank body 10A has an upper portion 11A defining an upper end 111A, and a lower portion 12A defining a lower end 121A. Accordingly, the upper portion 11A of the shank body 10A is preferably longer than the lower portion 12A thereof. The shank body 10A is frontwardly bent at a common edge 101A between the upper and lower portions 11A, 12A that when the shank body 10A is rest on the front surface of the drywall, the upper and lower ends 111A, 121A of the shank body 10A are biased against the drywall to enhance a strength of the shank body 10A.

The inserting body 20A is integrally and inclinedly extended from the upper portion 11A of the shank body 10A, wherein the inserting body 20A has a sharp tip 201A rearwardly and downwardly extended from the upper end 111A of the shank body 10A for inserting into the drywall until the shank body 10A is rest on a front surface of the drywall so as to suspendedly support the item on the front surface of the drywall.

The inserting body 20A has a neck portion 21A rearwardly and inclinedly extended from the upper end 111A of the shank body 10A and a teething head 22A which defines the sharp tip 201A thereat and is integrally extended from the neck portion 21A.

Accordingly, the neck portion 21A of the inserting body 20A is downwardly and rearwardly extended from the upper end 111A of the shank body 10A such that when the inserting body 20A is inserted into the drywall, the neck portion 21A of the inserting body 20A is inclinedly embedded into the drywall. An inclination angle of the inserting body 20A has a range from 45° to 70° with respect to the shank body 10A. Preferably, the inclination angle of the inserting body 20A is 60° with respect to the shank body 10A.

The teething head 22A is integrally and rearwardly extended from the neck portion 21A of the inserting body 20A, wherein the teething head 22A has a plurality of side engaging teeth 221A arranged in such a manner that when the inserting body 20A is inserted into the drywall, the corresponding engaging teeth 221A of the teething head 22A are engaged with the rear surface of the drywall, so as to enhance the pullout resistance of the drywall mount of the present invention.

In order to support the item at the shank body 10A, the shank body 10A further contains an aperture 110A provided at the upper portion 11A thereof for the item engaging with the aperture 110A. As it is mentioned above, the aperture 110A is used as a hanging aperture that the item can be engaged with the aperture 110A via a conventional hook to suspendedly hang the item on the drywall. In addition, a hanging adapter can be mounted to the shank body 10A through the aperture 110A to hang the heavier item, such as a cabinet, on the drywall.

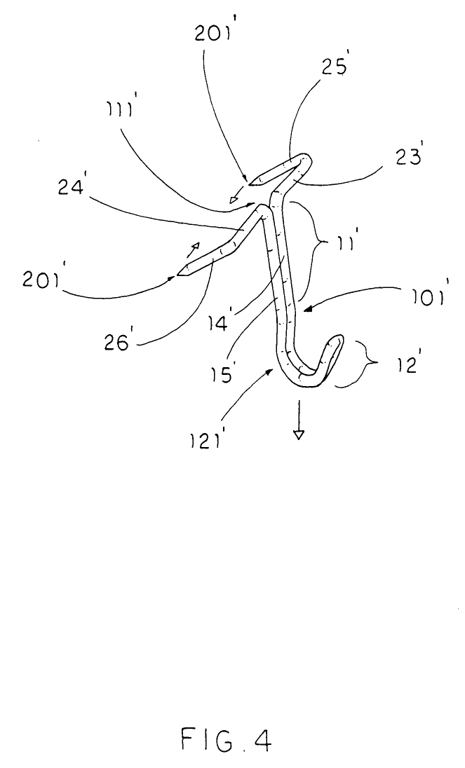

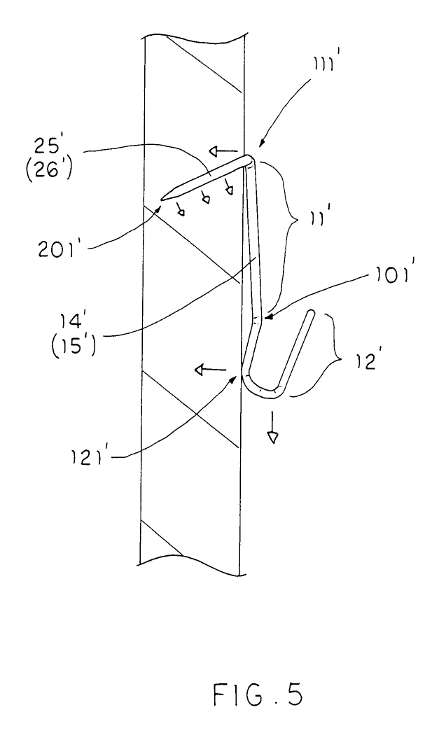

As shown in FIGS. 4 and 5, a drywall mount of a second embodiment illustrates an alternative mode of the first embodiment of the present invention, wherein the drywall mount comprises an elongated shank body 10′ and an inserting body 20′.

As shown in FIG. 4, the shank body 10′ has an upper portion 11′ defining an upper end 111′, and a lower portion 12′ defining a lower end 121′, wherein the shank body 10′ is adapted for holding the item in position. Accordingly, the upper portion 11′ of the shank body 10′ is preferably longer than the lower portion 12′ thereof.

The inserting body 20′ is integrally and inclinedly extended from the upper portion 11′ of the shank body 10′, wherein the inserting body 20′ has a sharp tip 201′ rearwardly and downwardly extended from the upper end 111′ of the shank body 10′ for inserting into the drywall until the shank body 10′ is rest on a front surface of the drywall so as to suspendedly support the item on the front surface of the drywall.

According to the second embodiment, the shank body 10′ is frontwardly bent at a common edge 101′ between the upper and lower portions 11′, 12′ that when the shank body 10′ is rest on the front surface of the drywall, the upper and lower ends 111′, 121′ of the shank body 10′ are biased against the drywall to enhance a strength of the shank body 10′. It is worth to mention that the bending structure of the shank body 10′ can enhance the shear strength thereof. In other words, when the inserting body 20′ is inserted into the drywall, the upper and lower ends 111′, 121′ of the shank body 10′ are substantially biased on the front surface of the drywall to define a clearance between a rear side of the shank body 10′ and the front surface of the drywall so as to form a two-point support on the drywall.

As shown in FIG. 4, the drywall mount of the second embodiment is made of an elongated metal wire bent in a predetermined configuration to form the shank body 10′ and an inserting body 20′ such that the shank body 10′ is integrally extended to the inserting body 20′ to form a one piece integrated structure of the drywall mount of the present invention to provide a rigid loading support for the item being hung on the drywall.

Accordingly, the shank body 10′ comprises an elongated metal wire bent in U-shape to form two elongated shafts 14′, 15′ extended alongside of each other and to define two upper ends 111′ of the elongated shafts 14′, 15′. Then, the two elongated shafts 14′, 15′ are bent to form the lower portion 12′ of the shank body 10′ as a hanging hook for coupling with the item so as to suspendedly hang the item on the drywall. It is worth to mention that the lower portion 12′ of the shank body 10′ can be formed in other configuration to hold the item in position by bending the elongated shafts 14′, 15′. It is worth to mention that the upper and lower ends 111′, 121′ of the elongated shafts 14′, 15′ are biased against the front surface of the drywall when the inserting body 20′ is inserted into the drywall.

The inserting body 20′ comprises two transverse arms 23′, 24′ sidewardly extended from the upper end 111′ of the shank body 10′ and two inserting heads 25′, 26′ integrally, rearwardly and inclinedly extended from two free ends of the transverse arms 23′, 24′ respectively for inserting into the drywall. As shown in FIG. 4, the transverse arms 23′, 24′ are integrally extended from the elongated shafts 14′, 15′ of the shank body 10′ respectively to form a T-shaped configuration. It is worth to mention that only two holes are formed on the drywall after the transverse arms 23′, 24′ of the drywall mount are inserted into the drywall so as to minimize the damage of the drywall without reducing the supporting strength of the drywall mount of the present invention.

Accordingly, the transverse arms 23′, 24′ are horizontally extended from the shank body 10′ and are arranged in such a manner that when the inserting heads 25′, 26′ insert into the drywall, the transverse arms 23′, 24′ are rest on the front surface of the drywall so as to prolong a distance between the free end of the transverse arm 23′, 24′ and the lower end of the shank body 10′. An inclination angle of each of the inserting heads 25′, 26′ has a range from 20° to 30° with respect to the shank body 10′.

As it is mentioned above, the drywall mount of the second embodiment is made of the metal wire wherein two end portions of the metal wire are bent to form the inserting heads 25′, 26′ respectively while the mid-portion of the metal wire is bent to form the transverse arms 23′, 24′ of the inserting body 20′ and the shank body 10′.

It is worth to mention that the length of each of the transverse arms 23′, 24′ can be selectively adjusted to prolong the distance between the free end of the transverse arm 23′, 24′ and the lower end of the shank body 10′. The longer length of each of the transverse arms 23′, 24′ is, the better loading support of the drywall mount of the present invention has. In addition, when the downward loading force is applied at the lower portion 12′ of the shank body 10′ by means of the weight of the item, the inserting body 20′ is adapted to evenly distribute the downward loading force to the surrounding area of the drywall. In other words, the inclination of the inserting body 20′ is adapted to prevent the distortion of the drywall mount when the downward loading force is applied at the lower portion 12′ of the shank body 10′. Furthermore, when the downward loading force is applied at the lower portion 12′ of the shank body 10′, the downward loading force will transmit to two inward pushing forces at the inserting heads 25′, 26′ so as to further enhance the pullout resistance of the drywall mount of the present invention.

Accordingly, the drywall mount of the present invention provides a simple mounting operation by inserting the inserting body 20, 20A, 20′ into the drywall without any pre-drilled aperture on the drywall.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A drywall mount for supporting an item on a drywall, comprising:
an elongated shank body, which is adapted for holding said item in position, having an upper portion defining an upper end, and a lower portion defining a lower end; and
an inserting body integrally and inclinedly extended from said upper portion of said shank body, wherein said inserting body has a sharp tip rearwardly and downwardly extended from said upper end of said shank body for inserting into said drywall until said shank body is rest on a front surface of said drywall so as to suspendedly support said item on said front surface of said drywall.

2. The drywall mount, as recited in claim 1, wherein said shank body is frontwardly bent at a common edge between said upper and lower portions that when said shank body is rest on said front surface of said drywall, said upper and lower ends of said shank body are biased against said drywall to enhance a strength of said shank body.

3. The drywall mount, as recited in claim 1, wherein said inserting body has a neck portion rearwardly and inclinedly extended from said upper end of said shank body and a teething head which defines said sharp tip thereat and is integrally extended from said neck portion, wherein a length of said neck portion is larger than a thickness of said drywall, such that when said inserting body inserts into said drywall, said neck portion is extended through said drywall while said teething head is substantially penetrated through a rear surface of said drywall.

4. The drywall mount, as recited in claim 2, wherein said inserting body has a neck portion rearwardly and inclinedly extended from said upper end of said shank body and a teething head which defines said sharp tip thereat and is integrally extended from said neck portion, wherein a length of said neck portion is larger than a thickness of said drywall, such that when said inserting body inserts into said drywall, said neck portion is extended through said drywall while said teething head is substantially penetrated through a rear surface of said drywall.

5. The drywall mount, as recited in claim 1, wherein said shank body further contains an aperture provided at said upper portion for a fastener affixing to said drywall through said aperture.

6. The drywall mount, as recited in claim 2, wherein said shank body further contains an aperture provided at said upper portion for a fastener affixing to said drywall through said aperture.

7. The drywall mount, as recited in claim 4, wherein said shank body further contains an aperture provided at said upper portion for a fastener affixing to said drywall through said aperture.

8. The drywall mount, as recited in claim 1, wherein an inclination angle of said inserting body is 60° with respect to said shank body.

9. The drywall mount, as recited in claim 4, wherein an inclination angle of said inserting body is 60° with respect to said shank body.

10. The drywall mount, as recited in claim 7, wherein an inclination angle of said inserting body is 60° with respect to said shank body.

11. The drywall mount, as recited in claim 1, wherein said inserting body comprises two transverse arms sidewardly extended from said upper end of said shank body and two inserting heads integrally, rearwardly and inclinedly extended from two free ends of said transverse arms respectively for inserting into said drywall.

12. The drywall mount, as recited in claim 2, wherein said inserting body comprises two transverse arms sidewardly extended from said upper end of said shank body and two inserting heads integrally, rearwardly and inclinedly extended from two free ends of said transverse arms respectively for inserting into said drywall.

13. The drywall mount, as recited in claim 11, wherein said transverse arms which are horizontally extended from said shank body and are arranged in such a manner that when said inserting heads insert into said drywall, said transverse arms are rest on said front surface of said drywall so as to prolong a distance between said free end of said transverse arm and said lower end of said shank body.

14. The drywall mount, as recited in claim 12, wherein said transverse arms which are horizontally extended from said shank body and are arranged in such a manner that when said inserting heads insert into said drywall, said transverse arms are rest on said front surface of said drywall so as to prolong a distance between said free end of said transverse arm and said lower end of said shank body.

15. The drywall mount, as recited in claim 11, wherein said shank body comprises an elongated metal wire bent in U-shape to form two elongated shafts extended alongside of each other and to define two upper ends of said elongated shafts to integrally extend to said transverse arms.

16. The drywall mount, as recited in claim 12, wherein said shank body comprises an elongated metal wire bent in U-shape to form two elongated shafts extended alongside of each other and to define two upper ends of said elongated shafts to integrally extend to said transverse arms.

17. The drywall mount, as recited in claim 14, wherein said shank body comprises an elongated metal wire bent in U-shape to form two elongated shafts extended alongside of each other and to define two upper ends of said elongated shafts to integrally extend to said transverse arms.

18. The drywall mount, as recited in claim 11, wherein an inclination angle of each of said inserting heads has a range from 20° to 30° with respect to said shank body.

19. The drywall mount, as recited in claim 14, wherein an inclination angle of each of said inserting heads has a range from 20° to 30° with respect to said shank body.

20. The drywall mount, as recited in claim 17, wherein an inclination angle of each of said inserting heads has a range from 20° to 30° with respect to said shank body.
